(19) United States
(12) Patent Application Publication
(10) Pub. No.: US 2004/0208004 A1
(43) Pub. Date: Oct. 21, 2004

(54) Direct current brushless vibration motor

(76) Inventor: Cheng-Fang Hsiao, Hsichih City (TW)

Correspondence Address: John S. Egbert, Harrison & Egbert, 7th Floor, 412 Main Street, Houston, TX, 77002, US

(21) Appl. No.: 10/687,115

(22) Filed: Oct. 17, 2003

(30) Foreign Application Priority Data
Dec. 27, 2002 (CN) 02294163.0

(51) Int. Cl. F21V 21/00

(52) U.S. Cl. 362/249

(57) ABSTRACT

A cluster lamp includes a mounting base to which a plurality of illumination tubes are adjustably fastened in a cluster by a fastening structure. The fastening structure includes a plurality of first pivoting seats and a plurality of second pivoting seats. The first pivoting seats are fastened to one end of the illumination tubes, whereas the second pivoting seats are fastened at intervals to the mounting base. The illumination tubes are fastened to the mounting base in clusters such that the first pivoting seats of the illumination tubes are engaged with the second pivoting seats of the mounting base.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates generally to a cluster lamp, and more particularly to a structure for fastening each of the illumination tubes with a mounting base of the cluster lamp.

### BACKGROUND OF THE INVENTION

A cluster lamp consists of a number of illumination tubes, each containing a light-emitting body. The cluster lamp is widely used for decorative purpose; nevertheless it poses a space problem. In another words, the conventional cluster lamp can not be easily stored or packaged for shipment in view of the fact that the illumination tubes are fixedly fastened with a mounting base of the conventional cluster lamp.

### BRIEF SUMMARY OF THE INVENTION

The primary objective of the present invention is to provide a cluster lamp with a structure for fastening a number of illumination tubes with a mounting base of the cluster lamp in such a way that the volume of a cluster of the illumination tubes can be downsized to facilitate the storing or transporting of the cluster lamp.

The fastening structure of the present invention comprises a plurality of second pivoting seats which are arranged in the mounting base of the cluster clamp, and a first pivoting seat which is located at one end of each illumination tube. The illumination tubes are pivotally fastened with the mounting base such that they are arranged in a cluster, and that the first pivoting seat of each one of the illumination tubes is engaged with one of the second pivoting seats of the mounting base.

The features and the advantages of the present invention will be more readily understood upon a thoughtful deliberation of the following detailed description of the preferred embodiments of the present invention with reference to the accompanying drawings.

### BRIEF DESCRIPTION OF THE SEVERAL VIEWS OF THE DRAWINGS

FIG. 1 shows a schematic plan view of a cluster lamp embodied in the present invention.

FIG. 2 shows a perspective view of the fastening structure of a first preferred embodiment of the present invention.

FIG. 3 shows an exploded view of the fastening structure of the first preferred embodiment of the present invention.

FIG. 4 shows a longitudinal sectional view of the fastening structure of the first preferred embodiment of the present invention in combination.

FIG. 5 shows a schematic plan view of a downsized cluster lamp of the present invention.

FIG. 6 shows an exploded view of the fastening structure of a second preferred embodiment of the present invention.

FIG. 7 shows an exploded view of the fastening structure of a third preferred embodiment of the present invention.

FIG. 8 shows a schematic plan view of the fastening structure of the third preferred embodiment of the present invention at work.

### DETAILED DESCRIPTION OF THE INVENTION

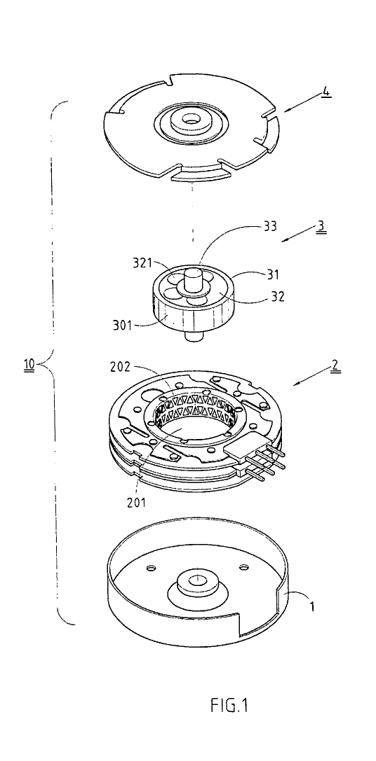

As shown in FIGS. 1-4, a cluster lamp embodied in the present invention comprises a tripod 11, a mounting base 10 located at a top end of the tripod 11, and a plurality of illumination tubes 20, each being fastened with the mounting base 10 by a fastening structure denoted by the letter.

The illumination tubes 20 are provided with a light-emitting body 21 and lamp cord 22. The illumination tubes 20 are located at a bottom end in a socket portion 31 of a connection member 30. The connection member 30 is further provided with a fastening portion 32 which is fastened to the mounting base 10.

The socket portion 31 of the connection member 30 is provided with a first pivoting seat 33 which is provided with a first pivoting hole 35, and a first toothed edge 51. The fastening portion 32 of the connection member 30 is provided with a second pivoting seat 34 which is provided with a pivoting hole 36 and a second toothed edge 52 engageable with the first toothed edge 51.

Each illumination tube 20 is pivotally fastened with the mounting base 10 in such a manner that the first pivoting seat 33 is pivoted with the second pivoting seat 34 of the mounting base 10 by a pivot 40 which is put through the first pivoting hole 35 and the second pivoting hole 36 in conjunction with a spring 53 and a stop ring 54. The pivot 40 is fastened at one end with a nut 41. Meanwhile, the first toothed edge 51 of the first pivoting seat 33 is engaged with the second toothed edge 52 of the second pivoting seat 34.

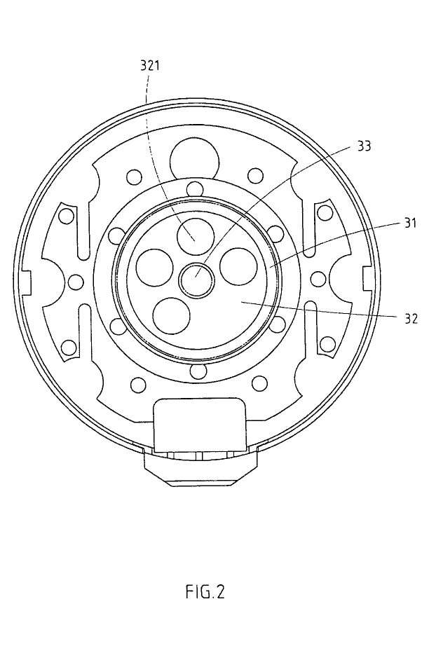

In light of the illumination tubes 20 being fastened pivotally with the mounting base 10, the illumination tubes 20 can be arranged in such a manner that a cluster volume of the illumination tubes 20 is downsized, as illustrated in FIG. 5.

As shown in FIG. 4, the first pivoting hole 35 of the first pivoting seat 33 is provided at one end with a shoulder 37. The spring 53 is fitted over the pivot 40 such that one end of the spring 53 is stopped by the shoulder 37, and that the other end of the spring 53 is stopped by the stop ring 54 which is in turn stopped by the head of the pivot 40. The spring 53 is used to provide a spring force to effect the locating of the first toothed edge 51 each time after the first toothed edge 51 is turned in relation to the second toothed edge 52.

As shown in FIG. 6, the first pivoting seat 33 of the illumination tubes 20 is provided with a locating knob 62 in place of the first toothed edge 51. Accordingly, the second pivoting seats 34 of the mounting base 10 are provided with a plurality of locating slots 61 in place of the second toothed edge 52. The first pivoting seat 33 and the second pivoting seat 34 are pivoted together such that the locating knob 62 is located in one of the locating slots 61 of the second pivoting seat 34. Each time when the first pivoting seat 33 is turned in relation to the second pivoting seat 34, the first pivoting seat 33 is located by means of the locating knob 62, which is located in one of the locating slots 61 of the second pivoting seat 34. In another words, each time when the illumination tubes 20 are turned in relation to the mounting base 10, the illumination tubes 20 can be located by means of the locating knob 62 of the first pivoting seat 33 of the illumination tubes 20.

As shown in FIGS. 7 and 8, the first pivoting seat 33 of the illumination tubes 20 is provided with a plurality of notches 71, whereas the second pivoting seats 34 of the mounting base 10 are provided with a tongue 72. As the first pivoting seat 33 is turned in relation to the second pivoting seat 34, the first pivoting seat 33 can be located by the tongue 72 whose tip engages one of the notches 71 of the first pivoting seat 33 of one of the illumination tubes 20, as illustrated in FIG. 8. In addition, an elastic ring 73 is disposed between the first pivoting seat 33 and the second pivoting seat 34. The elastic ring 73 is intended to provide the fastening structure of the present invention with an appropriate tightness in light of the lacking of the spring 53.

The embodiments of the present invention described above are to be regarded in all respects as being illustrative and nonrestrictive. Accordingly, the present invention may be embodied in other specific forms without deviating from the spirit thereof. The present invention is therefore to be limited only by the scope of the following claims.

1. A cluster lamp comprising:
a mounting base; and
a plurality of illumination tubes which are adjustably fastened to the mounting base by a fastening structure such that the illumination tubes are arranged in a cluster;
wherein said fastening structure comprises a plurality of first pivoting seats, and a plurality of second pivoting seats corresponding in number to said first pivoting seats, each of said first pivoting seats being fastened to one end of each of the illumination tubes, said second pivoting seats being fastened at intervals to the mounting base whereby said first pivoting seats of the illumination tubes are engaged with said second pivoting seats of the mounting base.

2. The cluster lamp as defined in claim 1, wherein said first pivoting seats are comprised of a first toothed edge; wherein said second pivoting seats are comprised of a second toothed edge engageable with said first toothed edge; wherein each of said first pivoting seats and each of said second pivoting seats are pivoted together by a pivot in conjunction with a spring such that said first toothed edge is engaged with said second toothed edge.

3. The cluster lamp as defined in claim 1, wherein said first pivoting seats are comprised of a locating knob; wherein said second pivoting seats are comprised of a plurality of locating slots corresponding in location to said locating knob; wherein each of said first pivoting seats and each of said second pivoting seats are pivoted together by a pivot in conjunction with a spring such that said locating knob is removably located in one of said locating slots.

4. The cluster lamp as defined in claim 1, wherein said first pivoting seats are comprised of a plurality of notches; wherein said second pivoting seats are comprised of a locating tongue; wherein each of said first pivoting seats and each of said second pivoting seats are pivoted together by a pivot in conjunction with an elastic ring such that a tip of said locating tongue engages one of said notches whereby said elastic ring is disposed between said first pivoting seat and said second pivoting seat.
